(19) United States
(12) Patent Application Publication
(10) Pub. No.: US 2007/0149027 A1
(43) Pub. Date: Jun. 28, 2007

(54) Signal connector resistant to plug/unplug force

(75) Inventors: Chao-Jung Chen, Taipei (TW); Chien-Lung Tseng, Taipei (TW); Yi-Lun Wu, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Avermedia Technologies, Inc.

(21) Appl. No.: 11/377,867

(22) Filed: Mar. 16, 2006

(30) Foreign Application Priority Data
Dec. 22, 2005 (TW) 094222423

(51) Int. Cl. H01R 13/625

(52) U.S. Cl. 439/345

(57) ABSTRACT

A signal connector comprises a main body for receiving a coaxial cable, thereby conducting electric connection between the signal connector and the coaxial cable; a first mounting portion coupled to and extending from the main body in a first direction and having a first mounting surface attachable to a circuit board; and a first coupling member coupled to the first mounting portion and protruding from the first mounting surface to be inserted into a hole in the circuit board, thereby securing the signal connector on the circuit board. The aforementioned structure makes the signal connector resistant to frequent plugging/unplugging actions.

### FIELD OF THE INVENTION

The present invention relates to a signal connector, and more particularly to a signal connector to be mounted on a substrate such as a printed circuit board.

### BACKGROUND OF THE INVENTION

For extending and diversifying the usage of electronic devices, many peripheral devices are developed. For example, video players (e.g. VCD player, DVD player, etc.) are often connected to TV sets (e.g. CRT, LCD, etc.) for displaying image data stored in video storage media (e.g. VCD, DVD, hard disk, etc.). That is to say, in addition to displaying TV programs, other functions of the TV set can be exhibited through connecting to a peripheral device like a video player. Another well-known example is the usage of the Personal Computer's peripherals such as mice, monitors, keyboards, printers, plotters, and network adapters, etc. These peripherals facilitate the operation of the personal computer and make its function more complete. In most cases, peripherals are physically connected to their master electronic devices through connectors. Electric signals are also transmitted between peripherals and master electronic devices through connectors. Electric connection is built when a plug of a peripheral device is inserted into a compatible socket or jack built in the master electronic device and removed by detaching the plug from the jack. Accordingly, electric current and electronic signals can be transferred or interrupted between the peripheral and the master electronic device. Therefore, the quality of the connector will not only influence the reliability of the power and signal transmission between a peripheral and a master device but also show effect on the operation of the entire master electronic device.

Various connectors are provided for different needs according to different specifications and characters of various electronic devices. These connectors include TNC series coaxial connectors, BNC series RF coaxial connectors, N series RF coaxial connectors, MICROAX (MCX) RF coaxial connectors, sub miniature version A (SMA) RF coaxial connectors, sub miniature version B (SMB) RF coaxial connectors, and sub miniature version C (SMC) RF coaxial connectors, etc. Each of the above-mentioned connectors has its own specific features and applicable frequency range. For satisfying the needs of portability, the electronic devices are designed to be smaller and smaller. Therefore, the connectors are also miniaturized. One of the examples is the development of MMCX (miniature microax) RF coaxial connectors. The MMCX RF coaxial connector can be mounted on the printed circuit board (PCB) by surface mount technology (SMT) such as surface mount soldering or surface mount gluing, and the resulting device can be arbitrarily rotated in 360 degrees. The above-mentioned advantages make the MMCX RF coaxial connectors become the main string among the connectors in the market.

FIG. 1(a) illustrates a conventional RF connector 10, while FIG. 1(b) indicates the assembling of the conventional RF connector 1 and the PCB 11. The conventional RF connector 10 has two junction surfaces 101 and 102 on two sides thereof. The conventional RF connector 10 is mounted to the PCB 11 by surface mounting the two junction surfaces 101 and 102 on the PCB 11, for example by soldering or gluing. Generally speaking, the strength for plugging into the jack 104 of a commercialized RF connector 10 is about 3.4 pounds, while unplugging from the jack 104 needs about 1.4-3.4 pounds of force. Under this circumstance, the life time of the connector 10 would be about 500 times plug/unplug actions. The surface mounting structure is subject to damage by more than 500 times plug/unplug actions. Since a RF connector is typically built in the housing of an electronic device and need not switch plugs frequently, 500-times plug/unplug actions may be satisfactory. However, once the RF connector is exposed from the housing to be used as a terminal socket for users' frequent plug/unplug actions, generally over 500 times, the RF connector may detached from the circuit board. The problem would become even worse if the applied SMT is a non-lead soldering process.

### SUMMARY OF THE INVENTION

Therefore, the present invention provides an improved connector structure to enhance the reliability of the combination of the connector and the printed circuit board so as to raise resistance to frequent plug/unplug actions.

The present invention relates to a signal connector to be coupled to a circuit board, which comprises a main body for receiving a coaxial cable, thereby conducting electric connection between the signal connector and the coaxial cable; a first mounting portion coupled to and extending from the main body in a first direction and having a first mounting surface attachable to the circuit board; and a first coupling member coupled to the first mounting portion and protruding from the first mounting surface to be inserted into a hole in the circuit board, thereby securing the signal connector on the circuit board.

The signal connector preferably further comprises a second mounting portion coupled to and extending from the main body in a second direction opposite to the first direction and having a second mounting surface attachable to the circuit board.

The signal connector preferably further comprises a second coupling member coupled to the second mounting portion and protruding from the second mounting surface to be inserted into another hole in the circuit board, thereby facilitating the securing of the signal connector on the circuit board.

In an embodiment, the first mounting portion and the second mounting portion further extend from the main body in a third direction different from the first and second directions.

In an embodiment, the first and second directions are perpendicular to the third direction that is parallel to the direction of the coaxial-cable plugging/unplugging force.

In an embodiment, the first and second mounting surfaces are attached to the circuit board by soldering or gluing.

In an embodiment, the first and second coupling members normally protrude from the first and second mounting surfaces, respectively.

The signal connector, for example, can be an ultra-micro radio frequency connector, a micro radio frequency connector or a sub miniature radio frequency connector.

The present invention also relates to a signal connector, which comprises a main body for receiving a coaxial cable, thereby conducting electric connection between the signal connector and the coaxial cable; a first mounting portion having a first mounting surface extending from the main body in a first direction; and a first coupling member coupled to the first mounting portion and protruding from the first mounting surface.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1(a) is a schematic perspective view of a conventional RF connector;

FIG. 1(b) is a schematic perspective view of a conventional RF connector to be mounted on a printed circuit board;

FIG. 2(a) is a schematic perspective view illustrating a structure of a signal connector according to an embodiment of the present invention; and

FIG. 2(b) is a schematic perspective view showing the signal connector of FIG. 2(a) to be mounted on a printed circuit board; and

FIG. 2(c) is a schematic perspective view of the assembled signal connector and printed circuit board.

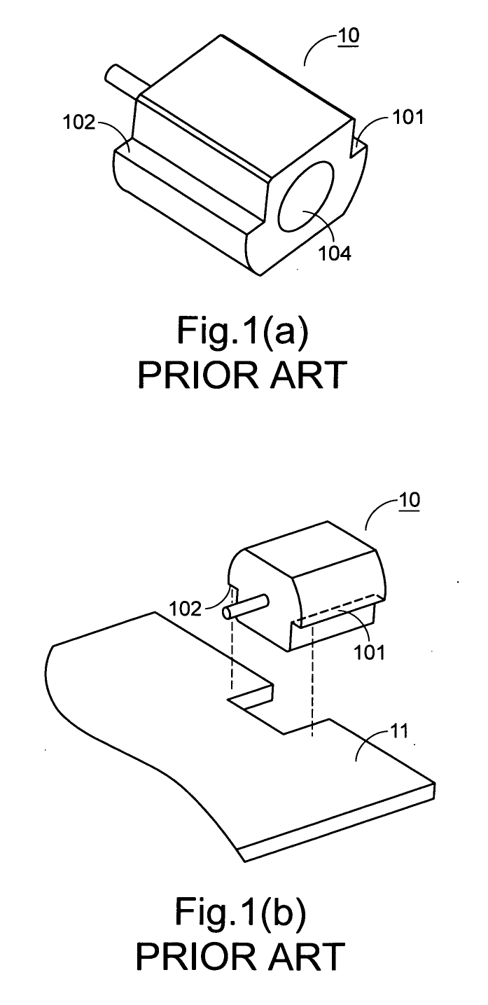

### DETAILED DESCRIPTION OF PREFERRED EMBODIMENTS

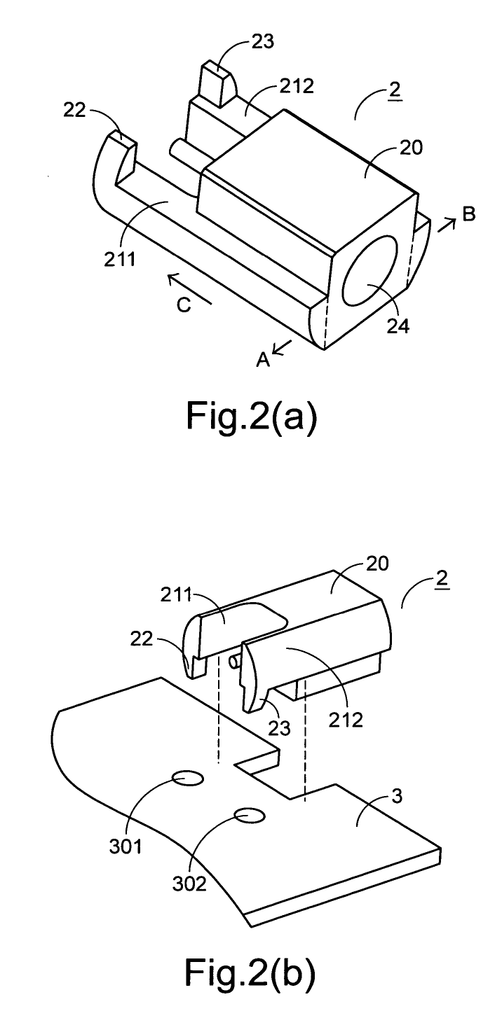

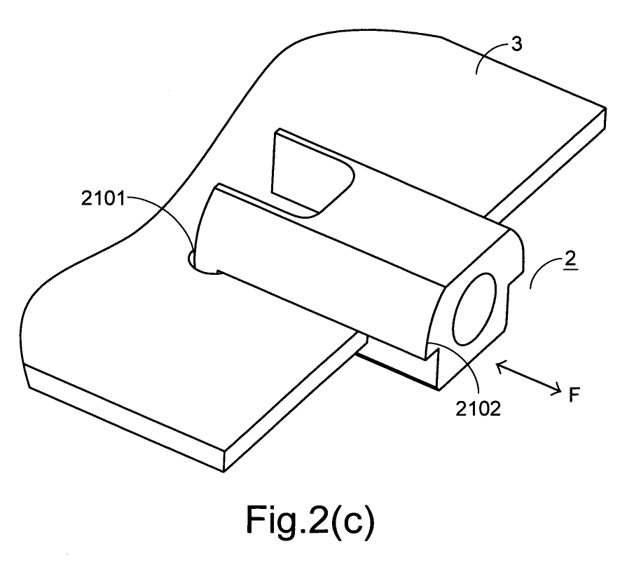

FIGS. 2(a), 2(b) and 2(c) illustrate an electronic device having a printed circuit board (PCB) 3 and a signal connector 2. The structure shows a firm combination between the connector 2 and the PCB 3. The connector 2 includes a main body 20, first and second mounting portions 211 and 212, first and second coupling members 22 and 23, and a jack portion 24. The jack 24 is provided for electric connection to a coaxial cable (not shown). The mounting portions 211 and 212 protrude from opposite sides of the main body 2, i.e. in the directions A and B, respectively. The first and second coupling members 22 and 23, which are preferably but not necessarily integrally formed with the first and second mounting portions 211 and 212, protrude from the ends of the first and second mounting portions 211 and 212, respectively, so as to provide hook structures for the connector 2. The first and second coupling members 22 and 23 penetrate through and engage with first and second through holes 301 and 302 of the PCB 3, respectively, and the bottoms of the mounting portions 211 and 212 are seated on and secured to the PCB 3 via suitable means, e.g. surface mount soldering or surface mount gluing, so as to accomplish the assembly of the connector 2 and the PCB 3 shown in FIG. 2(c).

In this embodiment, the first and second mounting portions 211 and 212 are designed to extend from the main body 2 in the direction C parallel to the coaxial-cable plugging/unplugging force F (preferably but not necessarily), and the first and second coupling members 22 and 23 are designed as a pin-like structure protrude from the first and second mounting portions 211 and 212 normally (preferably but not necessarily). Via such a structure, the connector 2 can be easily and firmly mounted to the PCB 3 by way of the engagement of the first and second coupling members 22 and 23 with the through holes 301 and 302 and the surface mounting of the first and second mounting portions 211 and 212 to the PCB 3. The extension 2101 of the mounting portions 211 and 212 enlarges the soldered or glued area with the PCB 3, and the coupling of the coupling members 22 and 23 with the through holes 301 and 302 provide enhanced resistance to plug/unplug actions, so as to prevent from unintentional detachment. Furthermore, improper plug/unplug angles and forces may cause damage to the surface mounting structure between the connector and the printed circuit board. The extension 2101 of the mounting portions 211 and 212 facilitate to disperse the effect of the external force exerted at the end 2102 while the plug/unplug actions of the coaxial cable 25 into/from the jack 24 are undergoing, thereby exhibiting from the damage.

To sum up, the present invention provides a firmer connecting architecture for a signal connector and a printed circuit board in a readily and reliably assembling way. Consequently, the lift time of the connector is remarkably increased and the damage probability caused by improper plugging/unplugging forces can be reduced. The present invention, although illustrated with a RF connector such as a MMCX RF coaxial connector, can also be applied to various connectors including MCX, SMA, SMB, SMC or any other micro/miniature connectors.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A signal connector to be coupled to a circuit board, comprising:
a main body for receiving a coaxial cable, thereby conducting electric connection between the signal connector and the coaxial cable;
a first mounting portion coupled to and extending from said main body in a first direction and having a first mounting surface attachable to the circuit board; and
a first coupling member coupled to said first mounting portion and protruding from said first mounting surface to be inserted into a hole in the circuit board, thereby securing the signal connector on the circuit board.

2. The signal connector according to claim 1 further comprising a second mounting portion coupled to and extending from said main body in a second direction opposite to said first direction, and having a second mounting surface attachable to the circuit board.

3. The signal connector according to claim 2 further comprising a second coupling member coupled to said second mounting portion and protruding from said second mounting surface to be inserted into another hole in the circuit board, thereby facilitating the securing of the signal connector on the circuit board.

4. The signal connector according to claim 3 wherein said first mounting portion and said second mounting portion further extend from said main body in a third direction different from said first and second directions.

5. The signal connector according to claim 4 wherein said first and second directions are perpendicular to said third direction that is parallel to the direction of the coaxial-cable plugging/unplugging force.

6. The signal connector according to claim 3 wherein said first and second mounting surfaces are attached to the circuit board by soldering or gluing.

7. The signal connector according to claim 3 wherein said first and second coupling members normally protrude from said first and second mounting surfaces, respectively.

8. The signal connector according to claim 1 being an ultra-micro radio frequency connector, a micro radio frequency connector or a sub miniature radio frequency connector.

9. A signal connector, comprising:
a main body for receiving a coaxial cable, thereby conducting electric connection between the signal connector and the coaxial cable;
a first mounting portion having a first mounting surface extending from said main body in a first direction; and
a first coupling member coupled to said first mounting portion and protruding from said first mounting surface.

10. The signal connector according to claim 9 further comprising a second mounting portion having a second mounting surface extending from said main body in a second direction.

11. The signal connector according to claim 10 further comprising a second coupling member coupled to said second mounting portion and protruding from said second mounting surface.

12. The signal connector according to claim 10 wherein said first mounting portion and said second mounting portion further extend from said main body in a third direction different from said first and second directions.

13. The signal connector according to claim 12 wherein said first and second directions are perpendicular to said third direction that is parallel to the direction of the coaxial-cable plugging/unplugging force.

14. The signal connector according to claim 10 wherein said first and second coupling members normally protrude from said first and second mounting surfaces, respectively.

15. The signal connector according to claim 9 being an ultra-micro radio frequency connector, a micro radio frequency connector or a sub miniature radio frequency connector.
